(19) United States
(12) Patent Application Publication
(10) Pub. No.: US 2009/0024628 A1
(43) Pub. Date: Jan. 22, 2009

(54) HOME MANAGEMENT, MAINTENANCE, REPAIR, REMODELING AND REDECORATION SYSTEM AND METHOD

(75) Inventors: Jorge ANGEL, Romeoville, IL (US); Mark Miklosz, Western Springs, IL (US); Daniel Jacobs, Geneva, IL (US); Anne McGrath, Chicago, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: UNITED STATES GYPSUM COMPANY, Chicago, IL (US)

(21) Appl. No.: 12/168,635

(22) Filed: Jul. 7, 2008

Related U.S. Application Data
(60) Provisional application No. 60/949,155, filed on Jul. 11, 2007.
(60) Provisional application No. 60/952,460, filed on Jul. 27, 2007.

(51) Int. Cl. G06F 17/30; G06F 17/50; H04N 7/00

(52) U.S. Cl. 707/9; 703/1; 348/36; 705/44; 707/E17.019; 707/E17.044; 348/E07.001

(57) ABSTRACT

Embodiments of the invention provide a home management system and method with a 360-degree virtual surface rendering application. Embodiments of the invention generate a listing of home improvement projects from the inspection report to be viewed through a user interface. Homeowners may manage, prioritize, rank, and educate themselves on each listed home improvement project. Embodiments of the invention may contain a 360-degree virtual surface rendering application allowing a homeowner to select different surface types for a room, and then view them on a re-rendered image of the room before purchasing the new surfaces.

### CROSS-REFERENCE TO RELATED APPLICATIONS

This patent application claims the benefit of U.S. Provisional Patent Application No. 60/952,460, filed Jul. 27, 2007, which is incorporated by reference. This patent application also claims the benefit of U.S. Provisional Patent Application No. 60/949,155, filed Jul. 11, 2007, which is incorporated by reference.

### FIELD OF THE INVENTION

Buying a home is the largest investment for most homeowners. Consequently, homeowners spend a tremendous amount of effort to protect this investment. The present application generally describes technologies applicable to a home management, maintenance, repair, remodeling and redecoration system and method.

### BRIEF SUMMARY OF THE INVENTION

Embodiments of the invention include a home management, maintenance, remodeling, repair, and/or redecoration system and method. Included in the description of applicable technology is a 360-degree virtual surface rendering application. Embodiments of the invention generate a listing of home improvement projects from an inspection report to be viewed through a web-accessible user interface. Homeowners may manage, rank, and educate themselves on each listed home improvement project. Embodiments of the invention include a 360-degree virtual surface rendering application that permits a homeowner to select different surface types for a room, and then view them on a re-rendered image.

### BRIEF DESCRIPTION OF THE SEVERAL VIEWS OF THE DRAWINGS

FIG. 1 is a general architectural overview of the home management, maintenance, remodeling, repair, and redecoration system and method;

FIG. 2 is a flow diagram illustrating an exemplary embodiment of the system and method of 360-degree virtual surface rendering application;

FIG. 3 is an exemplary user interface for use in accordance with an embodiment of the invention;

FIG. 4 is an exemplary user interface for use in accordance with an embodiment of the invention;

FIG. 5 is an exemplary user interface for use in accordance with an embodiment of the invention;

FIG. 6 is an exemplary user interface for use in accordance with an embodiment of the invention;

FIG. 7 is an exemplary user interface for use in accordance with an embodiment of the invention;

FIG. 8 is an exemplary 3-D panoramic image for use in accordance with an embodiment of the invention;

FIG. 9 is a exemplary unwarped 3-D panoramic image for use in accordance with an embodiment of the invention;

FIG. 10 is an exemplary user interface for use in accordance with an embodiment of the invention;

FIG. 11 is an exemplary user interface for use in accordance with an embodiment of the invention;

FIG. 12 is an exemplary user interface for use in accordance with an embodiment of the invention;

FIG. 13 is an exemplary user interface for use in accordance with an embodiment of the invention;

FIG. 14 is an exemplary user interface for use in accordance with an embodiment of the invention;

FIG. 15 is an exemplary user interface for use in accordance with an embodiment of the invention;

FIG. 16 is an exemplary user interface for use in accordance with an embodiment of the invention;

FIG. 17 is an exemplary user interface for use in accordance with an embodiment of the invention;

FIG. 18 is an exemplary user interface for use in accordance with an embodiment of the invention;

FIG. 19 is an exemplary user interface for use in accordance with an embodiment of the invention;

FIG. 20 is an exemplary user interface for use in accordance with an embodiment of the invention;

FIG. 21 is an exemplary user interface for use in accordance with an embodiment of the invention; and

FIG. 22 is an exemplary user interface for use in accordance with an embodiment of the invention.

### DETAILED DESCRIPTION OF THE INVENTION

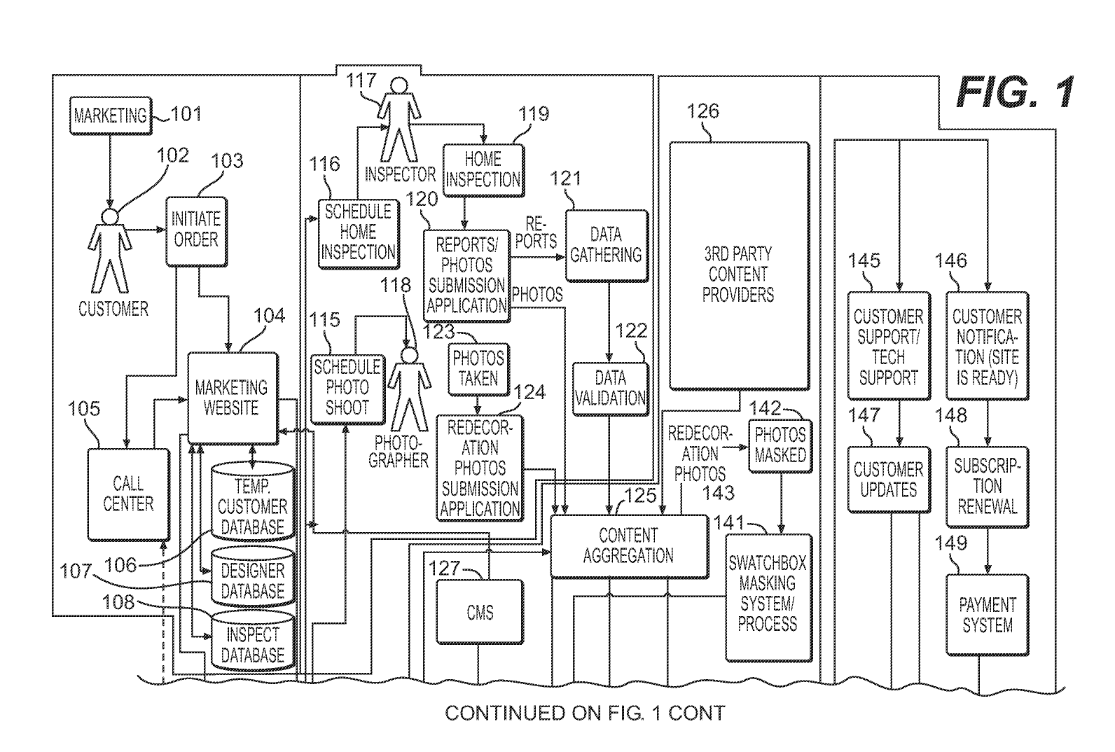

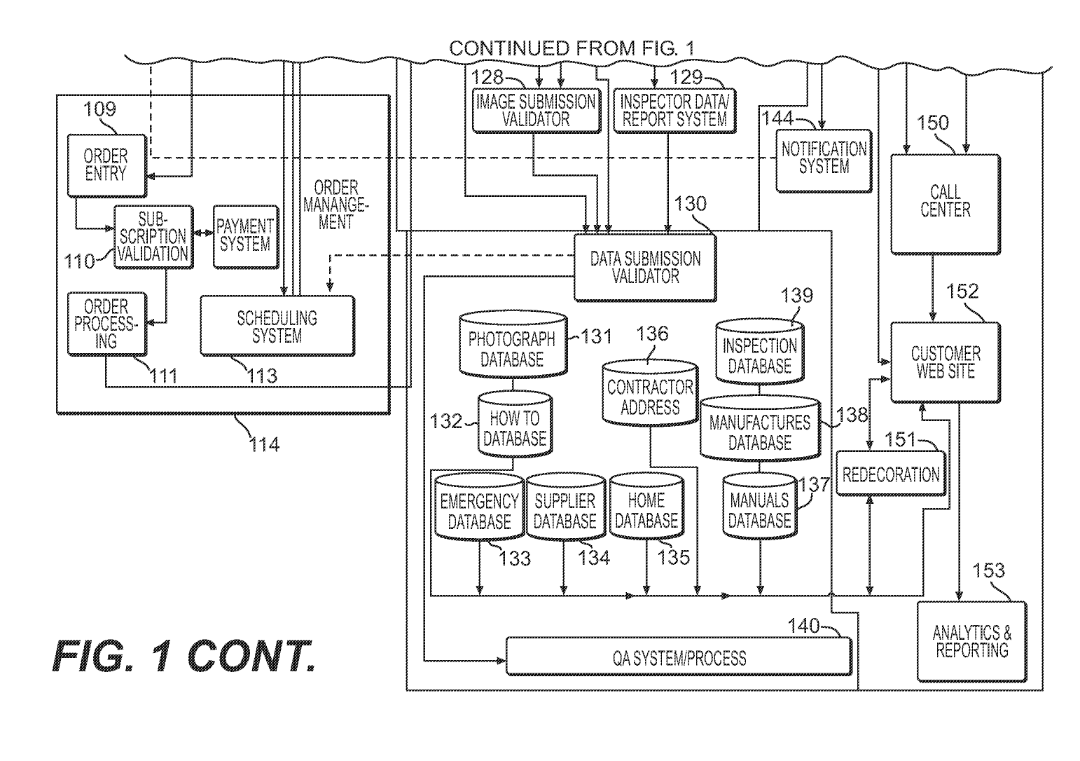

FIG. 1 is a general architectural overview of an embodiment of a home management system and method. In this embodiment, a marketing representative 101, which may be an individual or an electronic application, contacts a customer 102 to offer services. A customer thereafter initiates an order 103, which triggers a notification to a call center 105. In addition, the order triggers a marketing website to store customer order information in a temporary database 106, photographer database 107 and/or inspector database 108.

The marketing website thereafter notifies an order management system 114. This system includes an order entry function 109, a customer subscription validation function 110, which is coupled to a payment system, an order processing function 111, and a scheduling system 113. These functions and systems cooperate to accept customer orders, receive payments, and schedule jobs.

The scheduling system 113 includes applications to schedule a home inspection 116 and photography session 115 at a user's home. The scheduling and payment system of the order management system 114 thus allows customers to efficiently avail themselves of the services offered through the home management system. For example, an inspection report may generate a tuck pointing project for a chimney. A home management service provider thereafter supplies a user with an opportunity to contract potential suppliers, i.e., concrete sellers, and masonry contractors.

In the event that a user schedules an inspection, a home inspector 117 will conduct a home inspection 119 of a customer's residence. Upon completion of the inspection, the home inspector 117 submits a report, which is uploaded to an inspection database 108, via a submission application 120. A data gathering function 121 receives the home inspection reports from the submission application 120 and passes electronic data to a validation function 122. This function examines the data to insure that the home inspection report provided expected and necessary information.

The home inspector, as identified by reference numeral 117, will conduct the steps ordinarily associated with the type of inspection requested by the user. For example, a user may request a comprehensive home inspection of all aspects of the home. Alternatively, a user may request an inspection only as to certain home aspects, such as masonry, carpentry, mechanical, plumbing or electrical. In addition, the user may schedule a request for a photo shoot, as indicated by scheduling application 115. A photographer, as identified by reference numeral 118, will thereafter visit the premises and capture electronic images of the requested sections of the user's home. It is possible that the home inspector 117 and photographer 118 will be the same person. In a preferred embodiment, the photographer 118 will capture a 2-dimensional flat image and a 3-dimensional panoramic bowl image of each room of the house 123 requested by the user. These images are typically captured by a digital camera. The photographer 118 submits the captured digital images to a submission software application 124.

A content aggregation function 125 gathers content from the home inspection reports (120-122), captured digital images 120, redecoration digital images 124, and third party content providers 126. Third party content providers provide educational resources or vendor information to the customer marketing website. Images gathered by the content aggregate function are sent to an image submission validator 128. In addition, aggregated content is transmitted to the Inspector Data/Report System 129.

A Data Submission Validator 130 validates the data submitted from the CMS 127, the Image Submission Validator 128, the content aggregator 125, and the Inspector Data/Report System 129. CMS 127 also communicates with the marketing website server 104. The Data Submission Validator stores data in a plurality of databases that include, but is not limited to: (1) photograph database 131; (2) how-to database 132; (3) emergency information database 133; (4) supplier database 134; (5) home database 135; (6) contractor database 136; (7) manuals database 137; (8) manufacturers database 138; (9) inspection database 139. In addition, the data is submitted to a quality assurance system and process 140. Information contained in these databases is used to populate content displayed on a customer website 152. The information is also used in conjunction with redecoration data (e.g. suggestions for different paint, tile, countertops, cabinets, etc.) 151.

A notification system 144 notifies technical support of user information 145. User and technical support personnel provide customer updates through a call center 150 or the customer website 152. The customer is also notified that the customer website is ready for viewing 146. In addition, and as appropriate, a customer is queried to renew a subscription 148 to the home management service provider. When a customer renews a subscription, the payment system is notified of the subscription renewal 149. Further, a payment system notifies the call center of the subscription renewal 150. The call center may update a website 152 to provide technical support and customer information. Additionally, an analytics and reporting system 153 analyzes statistics that may be summarized in report form for the system administrators. Exemplary statistics may include the percentage of customers that resurface floors, percentage of inspection reports containing masonry defect, or the most popular wall paint color.

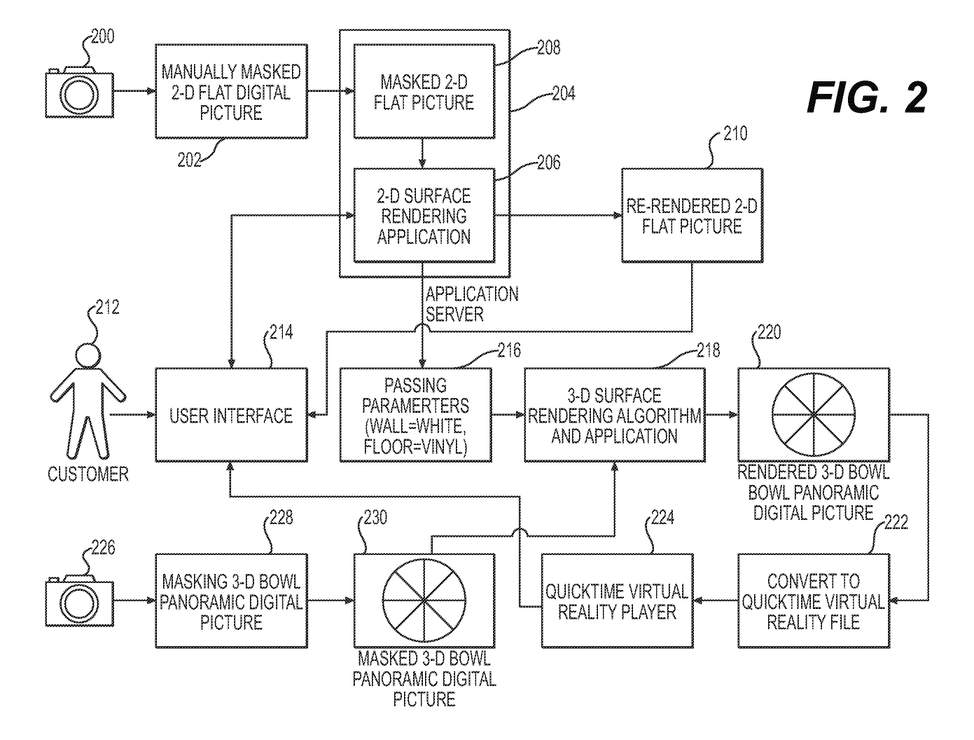

FIG. 2 describes an embodiment of a 360-degree virtual surface rendering application within the home management, maintenance, remodeling, repair, and redecoration system and method. As a first step a photographer captures at least two images with a digital camera (200 and 226). This may be the photographer 118 shown in FIG. 1. The first image is a standard two-dimensional flat digital image of a room in the new home (e.g. kitchen). At step 202, the two-dimensional digital image may require masking. Masking is a process that determines the edges of each surface within the digital image. Surfaces include areas within a digital photograph that a homeowner or contractor may create, modify, repair, or replace. For example, in a digital image of a kitchen, the walls, floors, countertops, and cabinets are all masked as separate surfaces because a homeowner or contractor can refinish the surfaces with different wall paint color, floor coverings, countertops (i.e. granite, Formica) or cabinets (i.e. cherry, oak, maple). At step 204, a 2-D surface rendering software application 206 located on an application server presents the masked 2-D flat digital image to a customer through a user interface 214. For example, a customer may select a surface such as a floor, and a surface type such as vinyl. In this example, the 2-D surface rendering application re-renders the 2-D flat digital image with the selected vinyl floor and white wall 210, and presents it to the customer through the user interface.

The second image captured by the photographer for the 360-degree virtual surface rendering application is a three-dimensional (3-D) bowl panoramic image. For example, the panoramic image may be taken with an 8.2 mega pixel digital camera and lens combination that is assembled and mounted on a tripod with a panoramic adapter using a panoramic adapter holder. Camera settings are set to Aperture Priority, lens priority set to f/18, focus is set to manual, lens focus is set to 0.3, and timer is set to 10 seconds. These settings are disclosed as exemplary and should not be construed as limiting the invention.

Once a 3-D panoramic image is taken with the exemplary settings, at step 228, it is masked to determine the edges of each surface 230. For example, in a digital image of a kitchen, the walls, floors, countertops, and cabinets are all masked as separate surfaces. A customer selects a surface with a different surface type using the 2-D surface rendering application 206 through a user interface 214. Once a customer selects surfaces and surface types (e.g., wall white, floor vinyl), and selects to view a 360-degree virtual reality image of the room, the followings steps in the application may be performed. At step 216, the 2-D surface rendering application passes parameters (e.g., wall=white, floor=vinyl) to a 3-D surface rendering algorithm and software application indicating the selected surfaces and surface types. At step 218, the 3-D surface rendering algorithm and application re-renders the 3-D bowl panoramic digital image with the new selected surfaces and surface types (e.g., wall white, floor=vinyl) 220. At step 222, the application may be required to convert the re-rendered 3-D panoramic image to a virtual reality file format, such as a QuickTime Virtual Reality file. At step 224, a virtual reality player presents the newly re-rendered surfaces to a customer through a user interface 214.

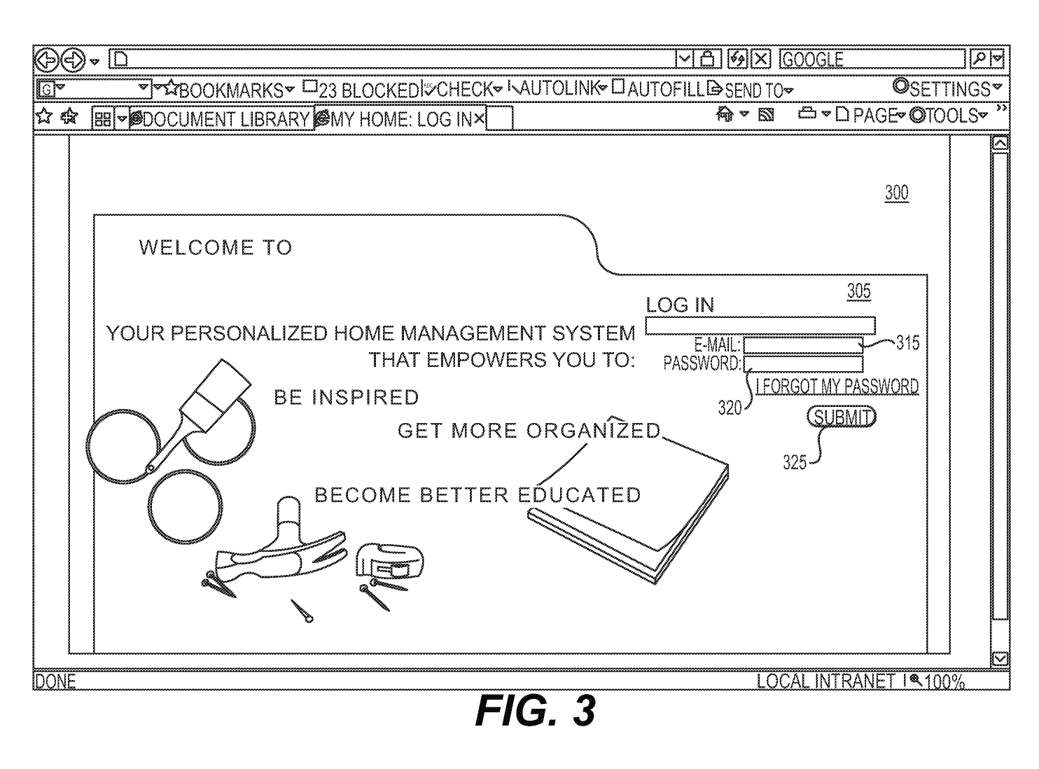

FIG. 3 is an exemplary user interface for use in accordance with an embodiment of the invention. FIG. 3 presents a user interface 300 to an embodiment of the home management, maintenance, remodeling, repair, and redecoration system and method with 360-degree surface rendering application. In a preferred embodiment, the system includes a user-changeable login 305 (that may include an email address 315) and password 320 to provide access to the customer's personal website and security to the home management service provider and its customers Once a login and password is entered, a customer may click the submit button 325 to enter the customer website. The customer website may be the one depicted in FIG. 1.

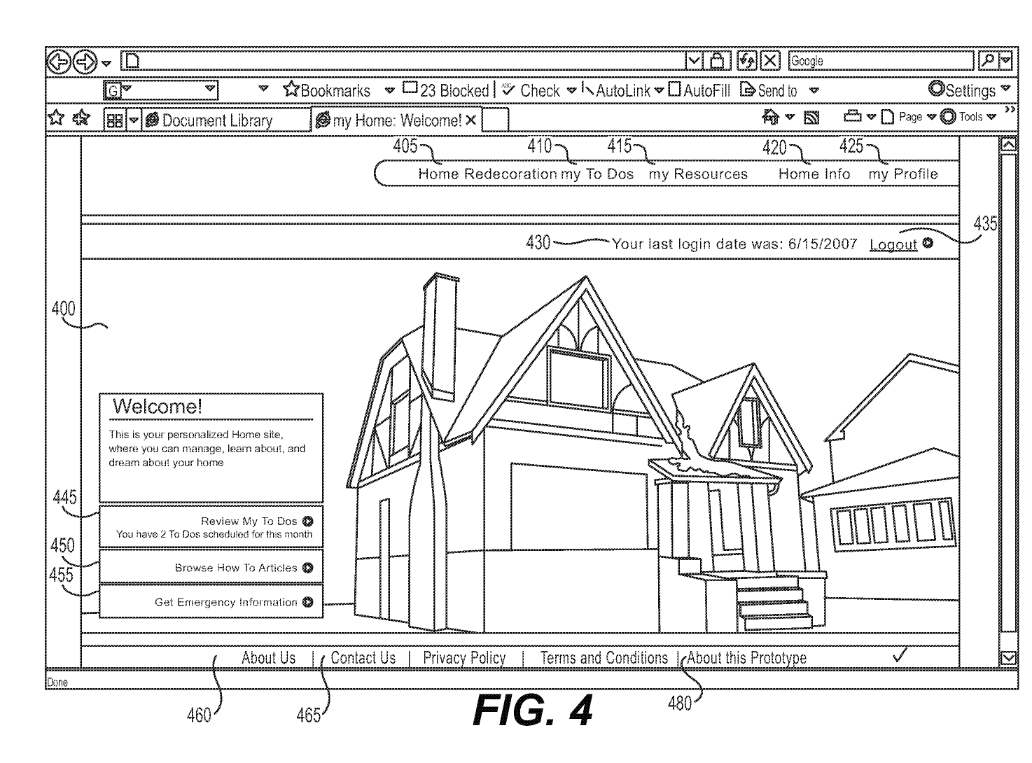

FIG. 4 is an exemplary user interface 400 for use in accordance with an embodiment of the invention that allows a customer to perform several home management functions. These include reviewing home improvement projects generated from an inspection report (i.e. “Review My To Dos” 445, “my To Dos 410”, “Home Info” 420), educating a customer on common home projects (i.e. “Browse How To Articles” 450, “my Resources” 415), and accessing the surface rendering application (i.e. “Home Redecoration 405). The customer website of this embodiment provides emergency information 455 and customer information (“my Profile” 425). A customer also has access to information about the home management service provider 460, and its contact information 465. The customer website further provides information on the website application 480. In addition, the website provides date the customer last logged in 430 and a link to logout of the application 435.

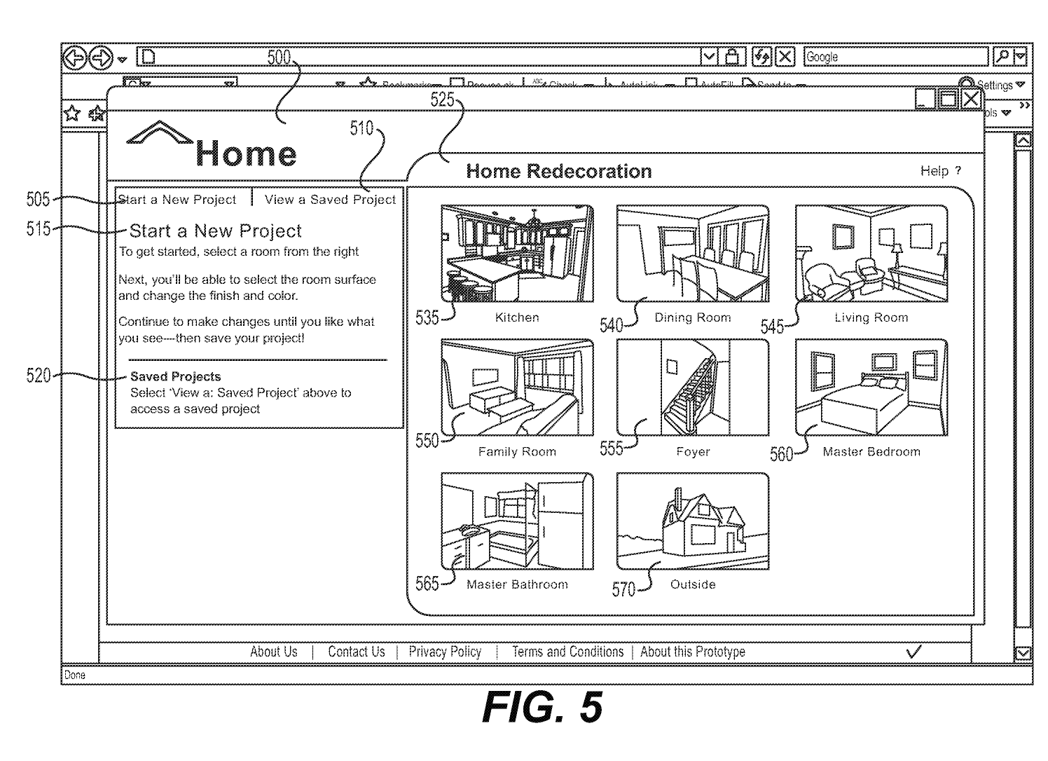

FIG. 5 is an exemplary user interface 500 that illustrates the surface rendering application. A “Home Redecoration” web page 525 is presented to the customer when clicking on the “Home Redecoration” link 405 in FIG. 4. A customer may start managing a new project (505, 515) or continue managing a saved project (510, 520). The customer may choose any room (535-570) in the home in order to select, render and visualize surfaces for home redecoration.

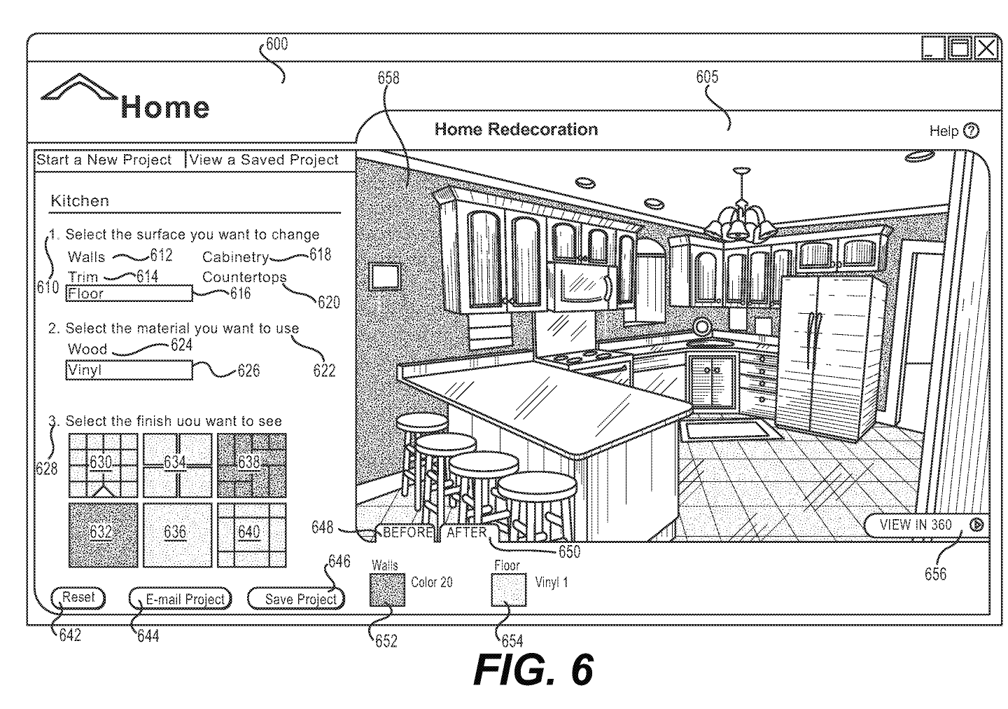

FIG. 6 is an exemplary user interface 600 that illustrates an embodiment of the invention. Web page 605 is presented to the customer after clicking the photograph link 535 in FIG. 5. In this example, the web application allows a customer to select different surfaces 610 such as walls 612, trim 614, floor 616, cabinetry 618, and countertops 620, and different surface materials 622 such as wood 624 or vinyl 626. In addition, a customer may select from several finishes for the surface (628-640). However, the invention is not limited to these surfaces, surface types, or finishes nor is it limited to the three choices of surface, surface type, and finish in home redecorating. The web application also allows a customer to reset 642 the choices for surface, surface type, and finish. It also allows a customer to email the project 644 and save the project 646 in a home management service provider database.

A current photograph of the room to be redecorated is displayed on the website 658. The application provides a “Before” 648 and “After” 650 rendering of the room photograph to the customer when surface materials and finishes are selected. In the example shown in FIG. 6 the wall surface is color 20 (652) and the floor surface is Vinyl 1 (654). The application allows the customer to view the re-rendered surfaces of a room using a 360 degree virtual reality program by clicking a link 656.

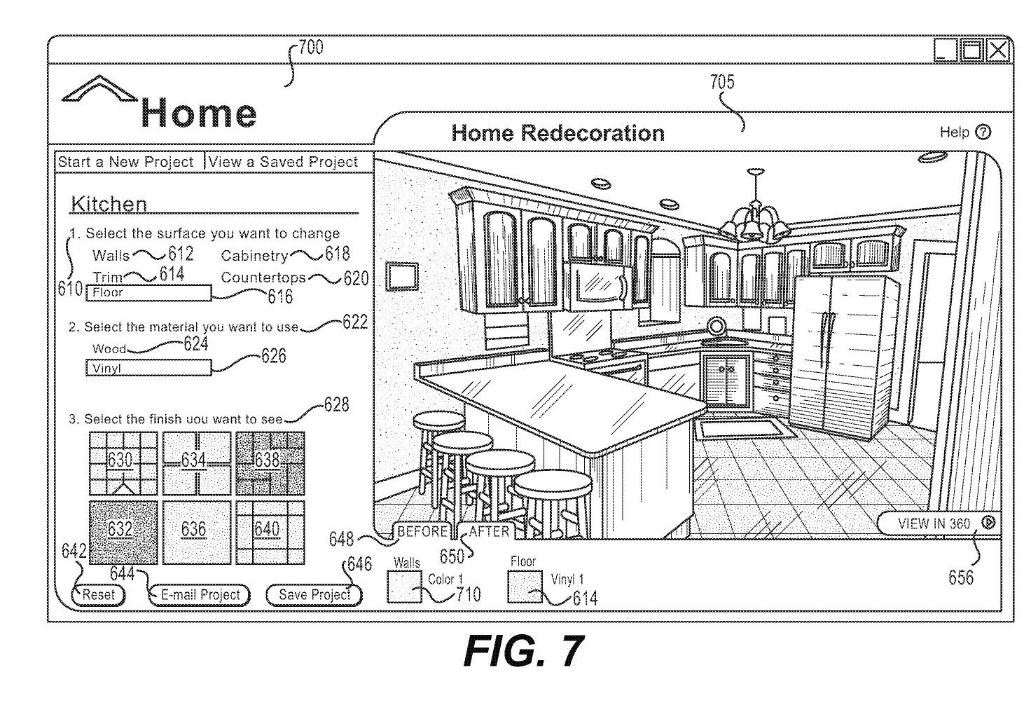

FIG. 7 is an exemplary user interface 700 that illustrates the re-rendering of a surface in a 2-D image. Note in FIG. 6 the walls were colored black (i.e. color 20) while in FIG. 7, the customer selects the walls to be white (i.e. color 1) 710. The application re-rendered the wall surface to be white and presented it to the customer through the user interface 705.

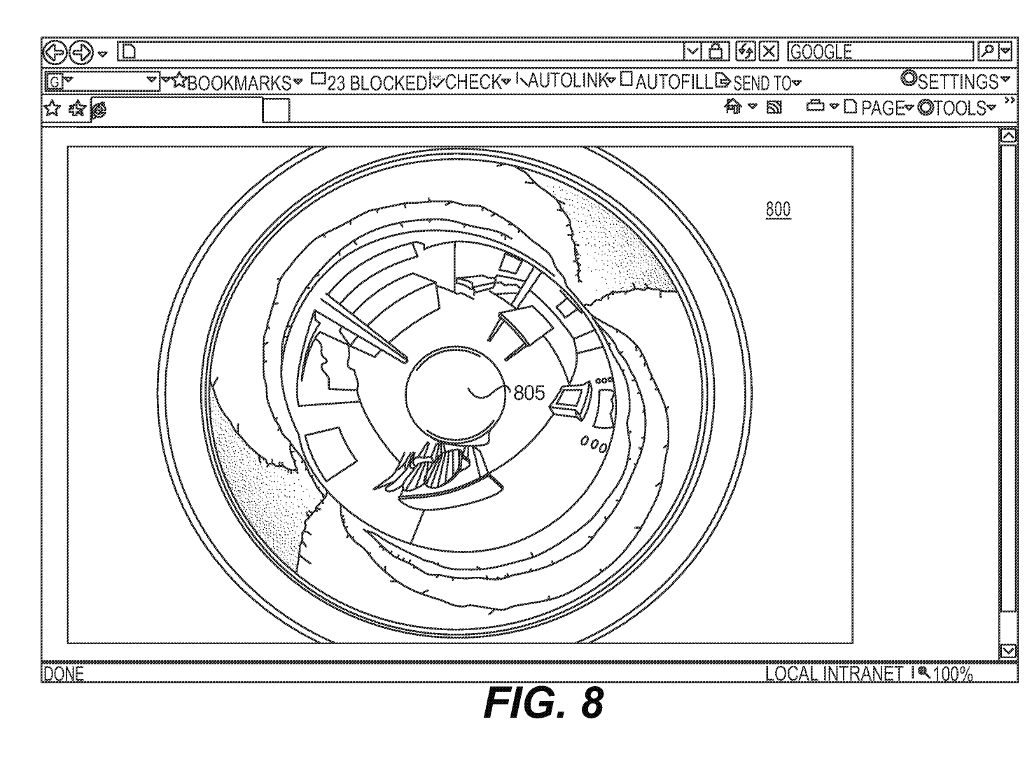

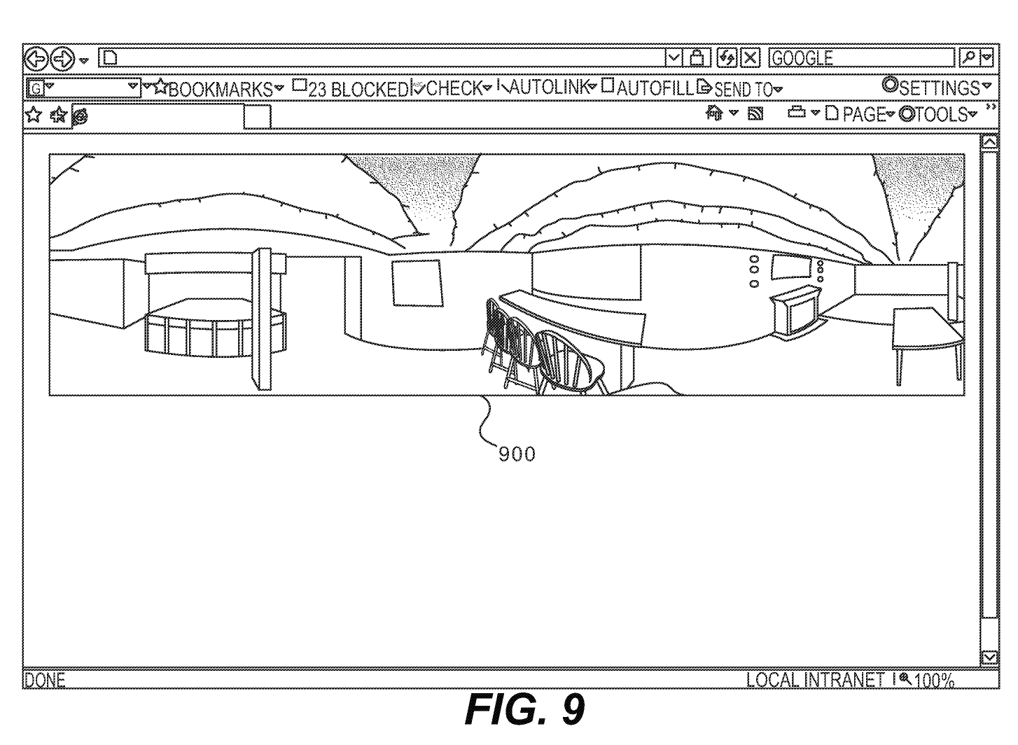

FIG. 8 is an exemplary 3-D panoramic image 800, in accordance to an embodiment of the invention. The image shown in FIG. 8 is a source file that is used to render a final image that is presented to a user. The circular disk 805 in the middle of the 3-D panoramic image is the panoramic adaptor and holder attached to the tripod of the camera. FIG. 9 illustrates an exemplary unwarped 3-D panoramic image 900. FIG. 9 is created by unfolding the 3-D image in FIG. 8 into a 2-D image. The 3-D panoramic warped image is masked to determine the different surfaces within the room such as the walls, floors, cabinets, and countertops. Using the 3-D panoramic warped image created with a panoramic adapter makes the 360-degree surface overlay application more efficient than other available means in the art. Note both a warped or unwarped 3-D panoramic image may be masked to determine different surfaces within a room. An alternative means to create an unwarped image is from several (e.g. 12) still images of different perspectives of a room and stitching them together to create a similar unwarped image.

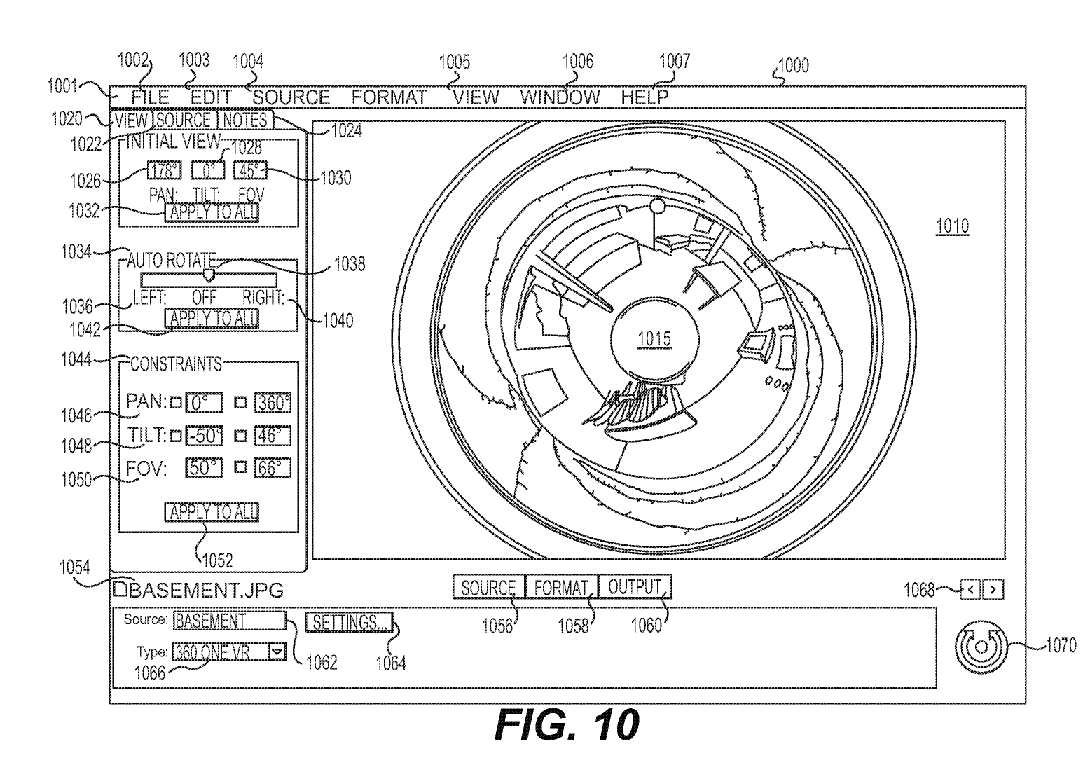

FIG. 10 is an exemplary user interface converting a virtual reality file format from a re-rendered 3-D panoramic image. The virtual reality file format software application 1000 allows a user several options to configure an image for 3-D virtual reality. The application organized the configurable options into several tabs. These include File 1001, Edit 1002, Source 1003, Format 1004, View 1005, Window 1006, and Help 1007. File 1001 options are shown in FIG. 10. The File tab 1001 contains sub-tabs View 1020, Source 1022, and Notes 1024. The View sub-tab shows the initial view of the image 1010 that includes the Pan 1026, Tilt 1028, and the FOV 1030. Once these parameters are selected, the user may apply them to the image 1010 by clicking the Apply to All button 1032. Further, virtual reality file format software application allows a user to Auto Rotate 1034 the image. The application may rotate the image to the left 1036, to the right 1040, or not at all (Off 1038). Applying auto rotation is done by clicking the Apply to All button 1042. A user may also provide constraints on the image 1044 in terms of Pan 1046, Tilt 1048, and FOV 1050. A user may apply these constraints by clicking the Apply to All button 1052. In addition, the application allows user to configure a source 1056, formatted 1058, or output 1060 image. The name of the source image file is also displayed 1054. The source image file 1062 may also be configured with different settings 1064. The type of source image file may also be displayed and selected 1066. Arrow buttons 1068 allow a user to view the image 1010 from different perspectives for convenience. The Unwarp button 1070 unfolds the 3-D panoramic image into a 2-D image similar to the one shown in FIG. 9.

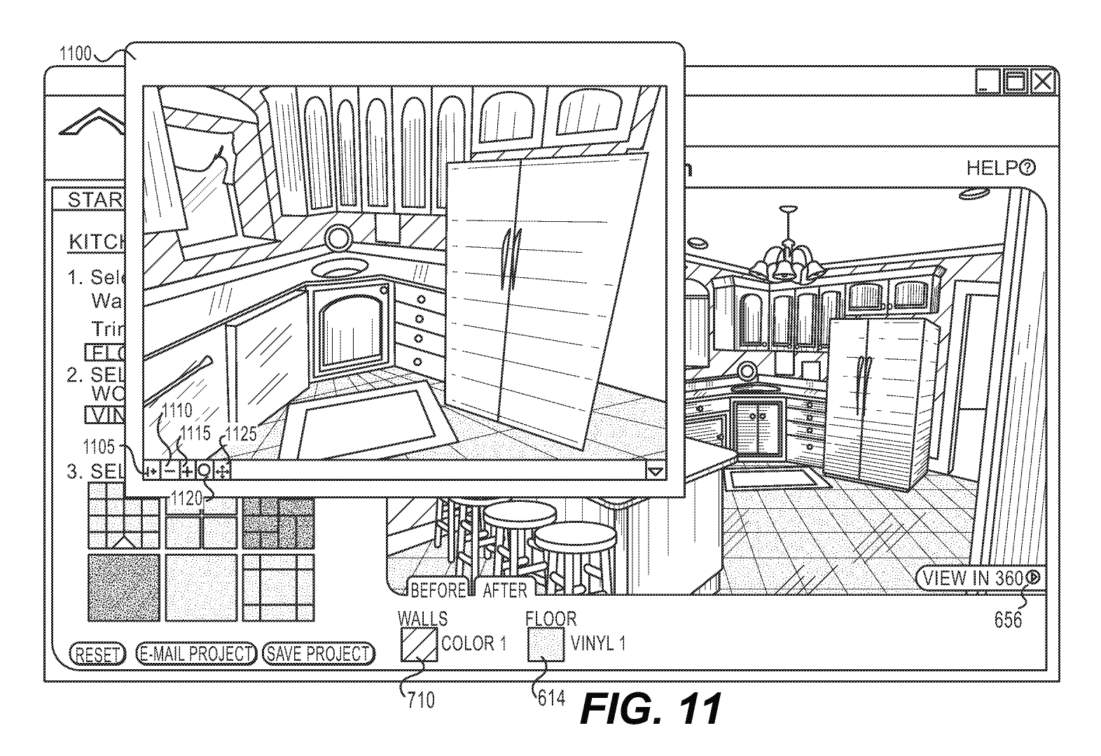

FIG. 11 is an exemplary user interface 1100 that allows the user to view a re-rendered 3-D image in a virtual reality file format using an appropriate virtual reality player (e.g. QuickTime virtual reality player, QuickTime 7.2 User's Guide is incorporated by reference). By clicking the View in 360 link 656, a user may view a re-rendered 360 degree 3-D image in a virtual reality file format using a virtual reality player. The re-rendered image has wall color as Color 1 710 and floor surface to be Vinyl 1 (614). The virtual reality player allows a user to rotate the image horizontally 1120 and vertically 1105. It also allows a user to zoom out 1110 and zoom in 1115 of the image. A user may also manipulate the image in different ways 1125.

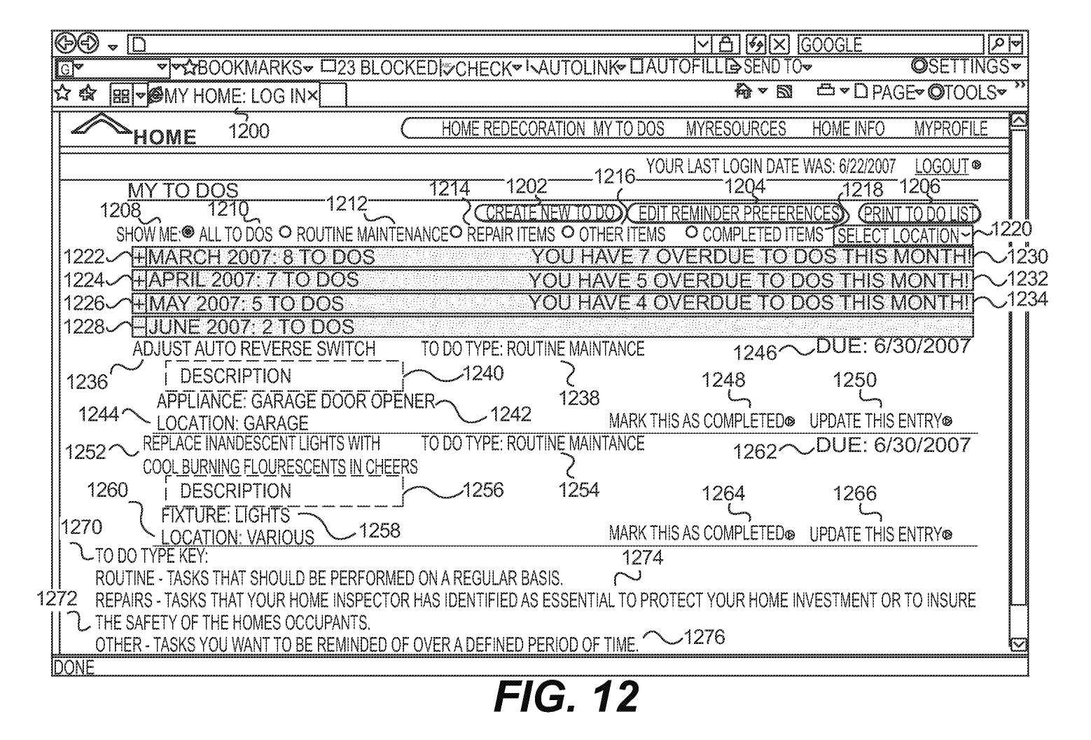

FIG. 12 is an exemplary user interface that presents the list of home improvements projects generated from a home inspection report that may be drafted during the exemplary method shown in FIG. 1. The home management, maintenance, remodeling, repair, and redecoration system and method allow the customer to manage, prioritize, rank, and obtain information on all the listed projects. The user interface 1200 is an example of a listing of projects when the “my To Dos” 410 link is selected. The user interface 1200 allows a user to create a new “To Do” project 1202, edit reminder preferences 1204, and print the “To Do” list 1206. “Show Me” 1208 buttons allow a user to see all the “To Do” projects 1210, or a sub-category of projects such as Routine Maintenance 1212, Repair Items 1214, Other items 1216, Completed Items 1218 and Items by Location 1220 (e.g. kitchen, bathroom, exterior, landscaping, etc.) Links (1222-1228) on the user interface allow a user to open and close a month's “To Do” list. Further, the user interface 1200 displays the number of overdue “To Do” projects in a month (1230-1234). A “To Do” project is listed with a name (1236, 1252), type (1238, 1254), and description (1240, 1256). In addition, the appliance or fixture (1242, 1258) and location (1244, 1260) are also listed. A due date (1246, 1262) is also provided and a link to mark the project as completed (1248, 1264), or update the entry of the project (1250, 1266). A user is provided with a Key 1270 to explain certain terms describing a project (1272, 1274, and 1276).

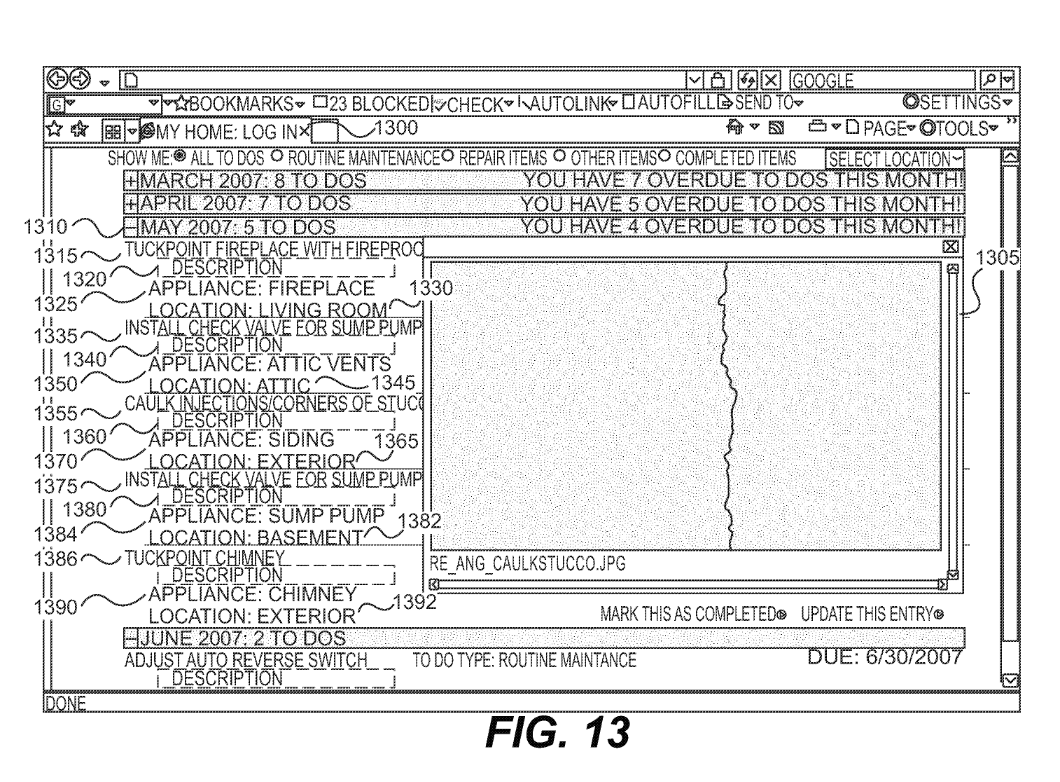

FIG. 13 is an exemplary user interface that presents a more detailed list of home improvements that may include digital photographs. Similar to the list of projects displayed in FIG. 12, the user interface 1300 lists 1310 project with a name (1315, 1335, 1355, 1375, 1386) and description (1320, 1340, 1360, and 1380), fixture or appliance (1325, 1345, 1365, 1382, and 1390), and location (1330, 1350, 1370, 1384, and 1392). Clicking on a name of a project allows a user to view a digital image of the area in need of repair 1305 to assess the project. These digital images are taken by the home inspector and submitted to the home management service provider to display on the customer website (See FIG. 1).

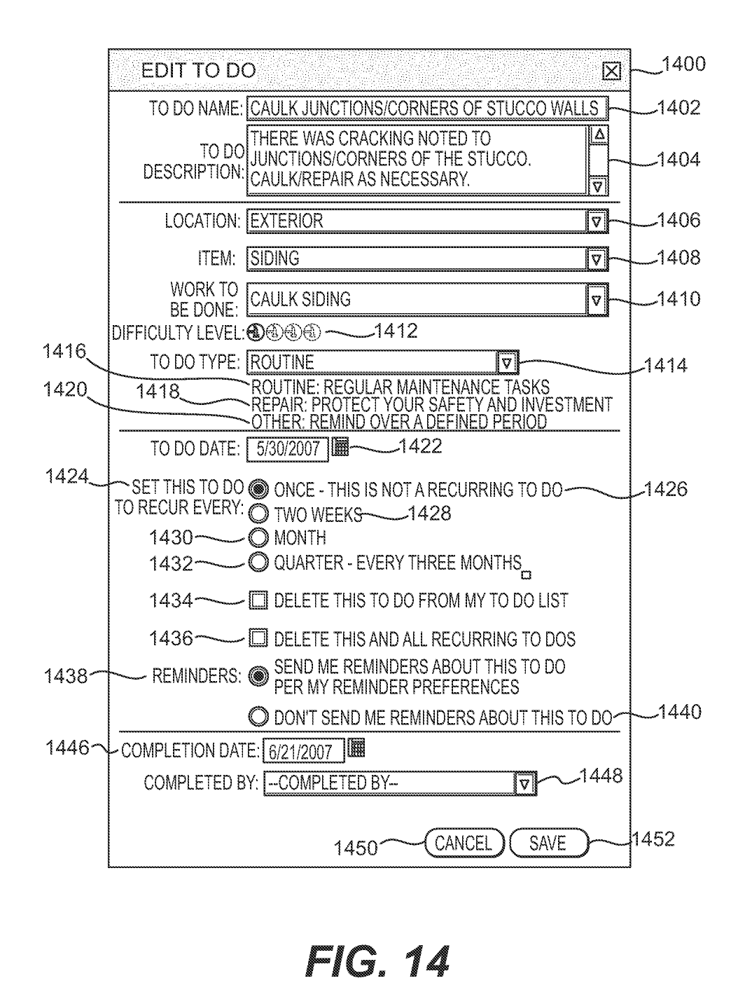

FIG. 14 is an exemplary user interface that manages a home improvement project by configuring certain parameters according to customer preferences. The user interface 1400 allows a user to edit an entry of a project in the “To Do” List. The parameters that may be edited by a user include, but are not limited to, name 1402, description 1404, location 1406, item 1408, Work to Be Done 1410, difficulty level 1412, date 1422, and type 1414. The user interface provides description of different types of projects (1416-1420). Additional project parameters may include, but are not limited to, recurrence of project 1424 and reminder of project 1438. Recurrence of project may include, but is not limited to, one week 1426, two weeks 1428, month 1430, and quarter 1432. A user may delete a project 1434 or delete all recurring projects 1436. A reminder of the project may be sent according to user reminder preferences 1438 or not at all 1440. A user may also set a completion date 1446 and a person the project was completed by 1448. A user may cancel 1450 or save 1452 the edits to the project. The parameters shown in FIG. 14 are exemplary and are not intended to limit the invention.

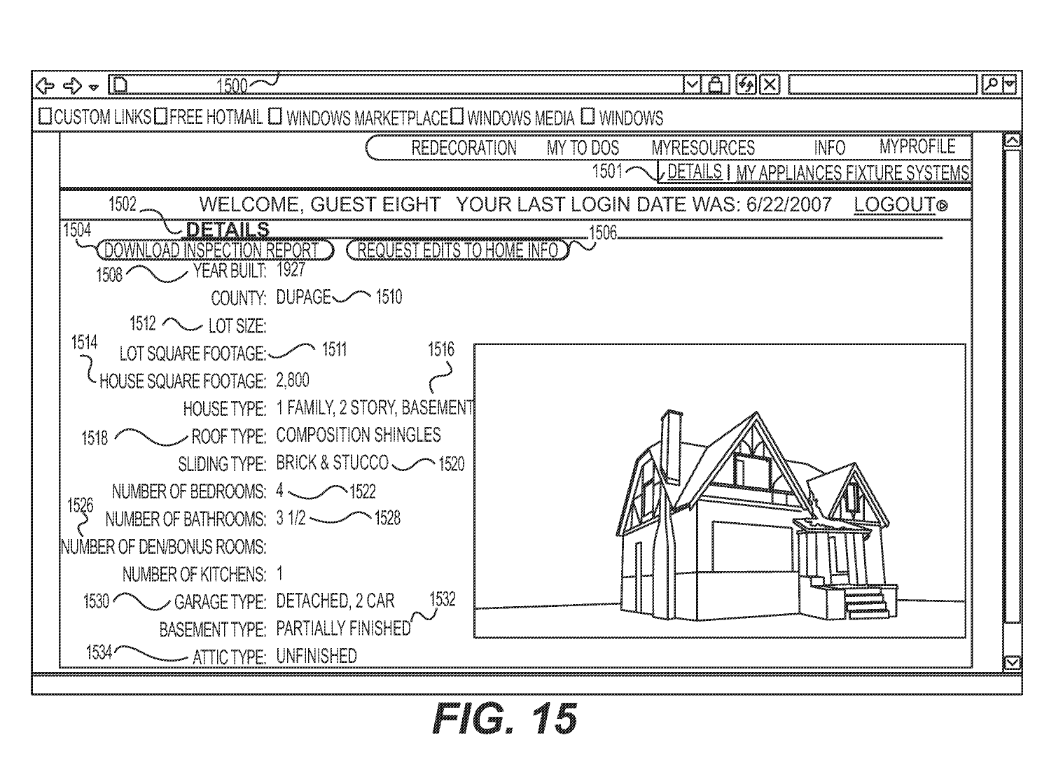

FIG. 15 is an exemplary user interface 1500 that provides detailed information 1502 on the customer's home such as, but not limited to, the home's age 1508, resident county 1510, lot size 1512, lot square footage 1511, house square footage 1514, house type 1516, roof type 1518, siding type 1520, number of bedrooms 1522, number of bathrooms 1524, number of den/bonus rooms 1526, number of kitchens 1528, garage type 1530, basement type 1532, and attic type 1534. This information is provided by clicking the Info link 420 on FIG. 4 and the Details link 1501. The home management service provider gathers and displays this information from an inspection report. A customer may download the inspection report through the user interface 1504. In addition, a customer may edit the home information, adding or modifying the home details 1506.

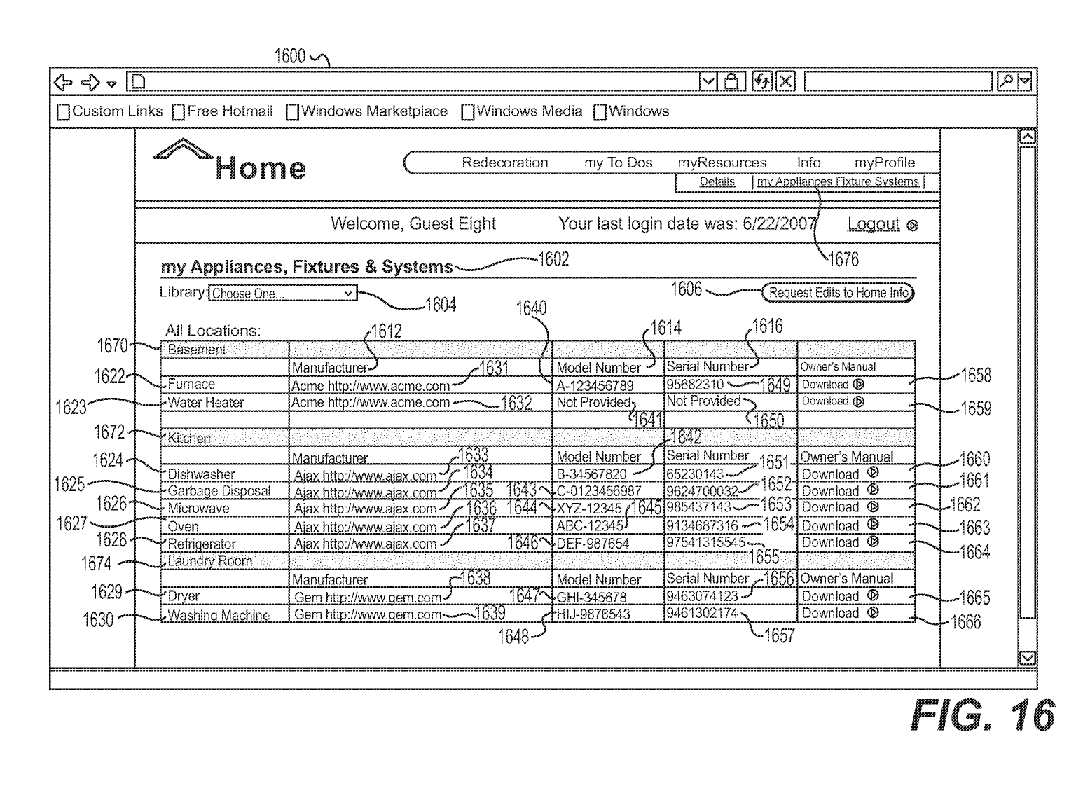

FIG. 16 is an exemplary user interface 1600 that displays information on the appliances, fixtures, and systems in a home 1602. This information is provided by clicking the Info link 420 in FIG. 4 and the “my Appliances Fixtures Systems” link 1676. The information displayed on the user interface is gathered from an inspector's report that includes, but is not limited to, the manufacturer 1612, model number 1614, serial number 1616, and type of each appliance, fixture, and system (1622-1630). The information may be organized according to each room of the home (1670-1674). A home management system may also provide information such as the manufacturer website (1631-1639), the model number (1640-1648) and serial number (1649-1657), and an owner's manual (1658-1666) for each appliance, fixture, and system. The user interface may also display a portion of the appliances, fixtures, and system according to location, manufacturer, or system type 1604. A customer may also request to make edits to home information 1606.

In addition, a customer may upload information to the home management system through the user interface. For example, a customer may purchase a lawn mower, garage door opener, and a snow blower and store all these appliances in the garage. The customer may upload the receipts and owner's manuals for each appliance through the user interface and store it on the home management system. The customer may organize the information into any organizational scheme using electronic folders through the user interface (i.e. by location/room, manufacturer, etc.).

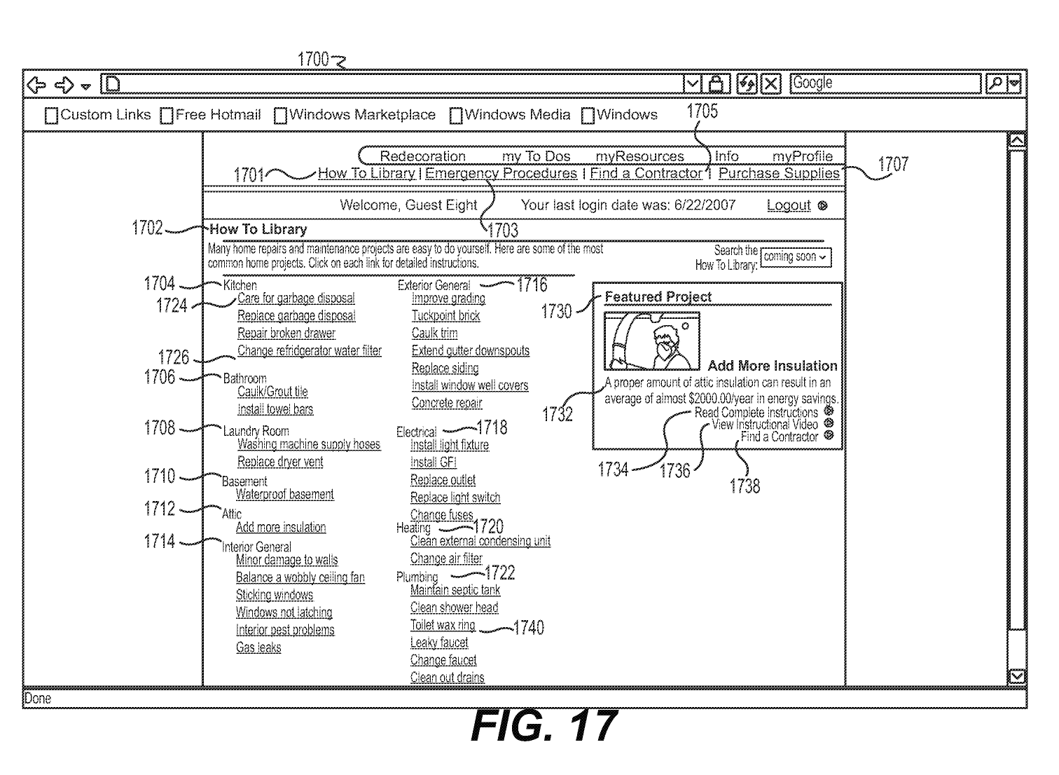

FIG. 17 is an exemplary user interface that 1700 provides information on several home maintenance, remodeling, redecorating, and repair projects. A customer is presented with How to Library 1702 user interface when clicking the my Resources link 415 and the How to Library link 1701. Other links (1703-1707) provide other resource information. The projects may be organized and displayed according to each room or system of the home (1704-1722). The user interface also provides a list of projects to access information such as Care for Garbage Disposal 1724, Change Refrigerator Water Filter 1726 and Leaky Faucet 1740. There is also a featured project that provides information on adding insulation to a customer's home 1730. Each piece of library information for a project may include a description of the benefit of the project 1732, instructions 1734, instructional video 1736, and a link to find a contractor to perform the project 1738.

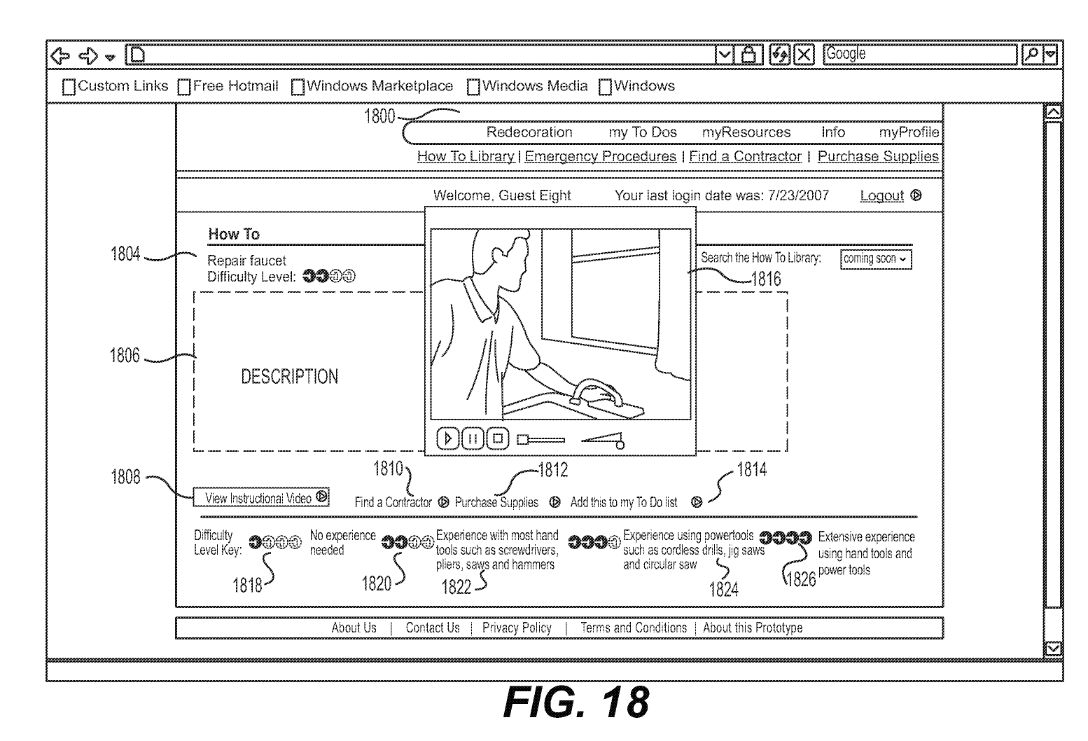

FIG. 18 is an exemplary user interface 1800 that provides information on a specific home maintenance, remodeling, redecorating or repair project. It provides a customer with the difficulty level 1804, the tools and experience needed for the project as well as a description of the project 1806. An instructional video is provided 1816 by clicking a link 1808. A customer may also click links to find a contractor 1810, purchase supplies 1812, and add the project to the To Do List 1814. The bottom of the user interface is a difficulty level key (1818-1826).

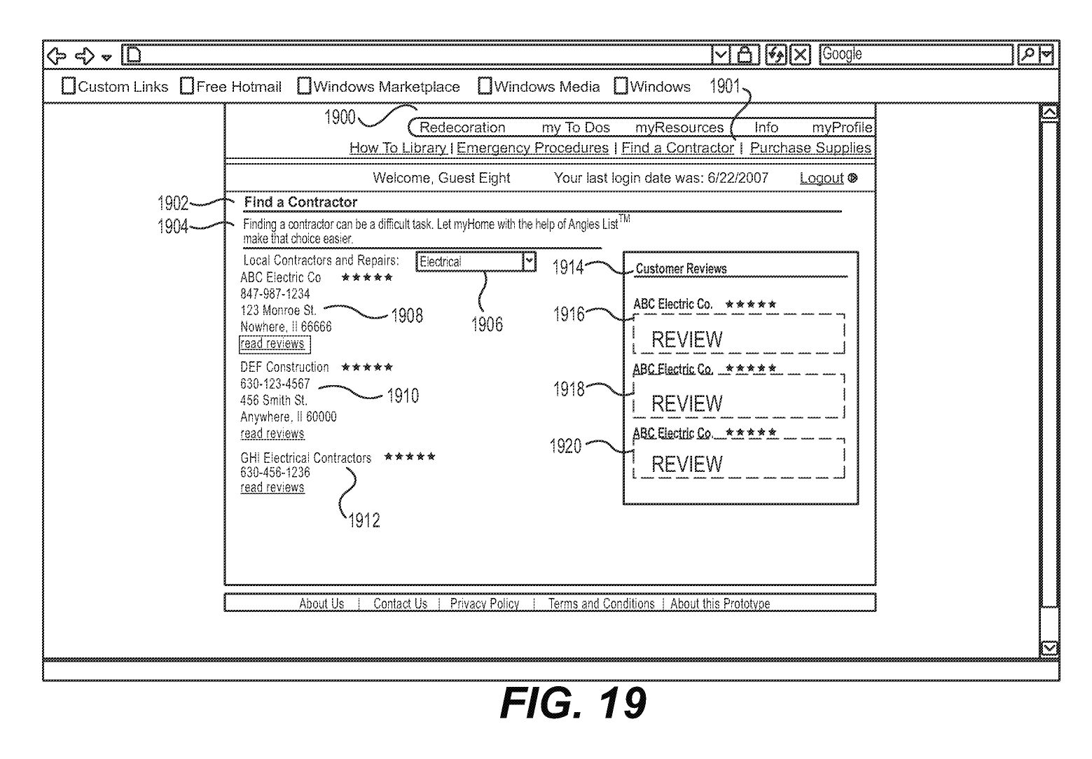

FIG. 19 is an exemplary user interface 1900 that allows a user to find a local contractor to perform a variety of home maintenance, remodeling, redecorating and repair projects (1902 and 1904). These include, but are not limited to, plumbers, electricians, roofers, painters, masons, general contractors, etc. 1906. The home management system locates contractors (1908-1912) based on customer's zip code, or by street address using geopoint technologies. Customers may choose to locate contractors within a specific mile radius of the home (e.g. 5, 10, or 25 mile radius from a customer's home). In addition, the home management system provides reviews 1914 from other customers on the quality of work for each contractor (1916-1920). The user interface 1900 shown in FIG. 19 is provided to the customer by clicking the my Resources link 415 and the Find a Contractor link 1901.

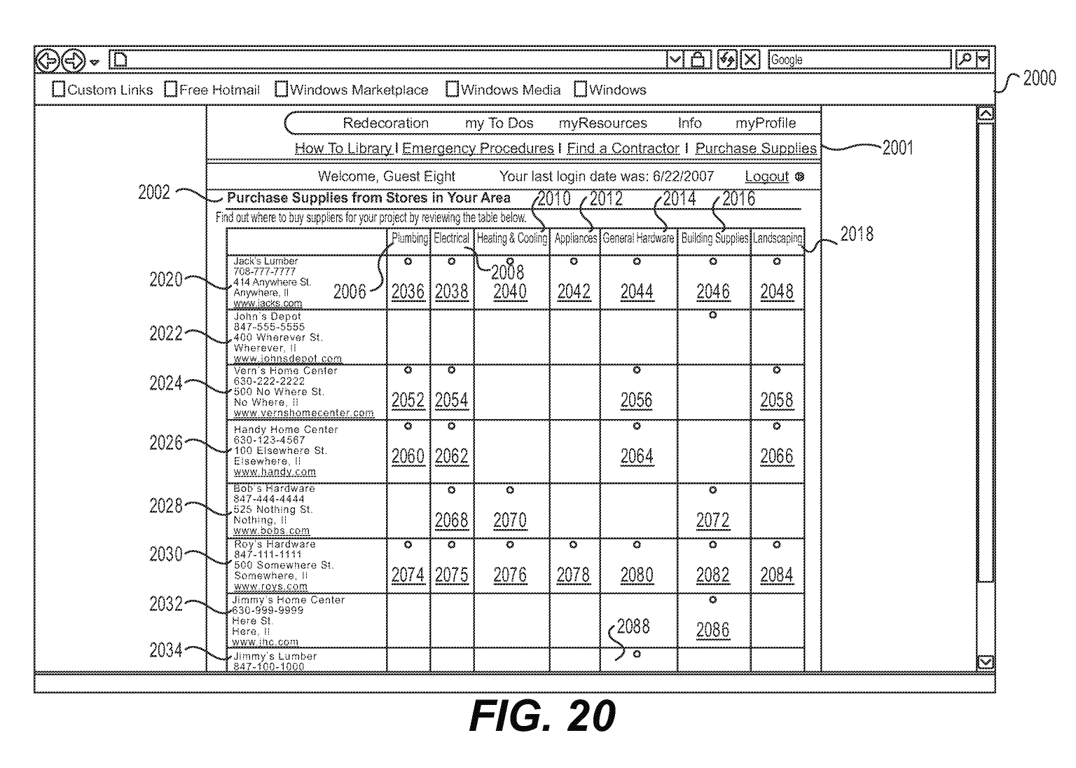

FIG. 20 is an exemplary user interface 2000 that allows a user to find stores to purchase supplies for home maintenance, remodeling, redecorating, or repair projects 2002. Stores are located and displayed based on customer zip code, or by street address using geopoint technologies. Customers may choose suppliers within a specific radius of the home (e.g. 5, 10, or 25 mile radius from a customer's home). The home management system may organize the suppliers according the type of supplies they provide, such as, but not limited to, plumbing 2006, electrical 2008, flooring, heating and cooling 2010, appliances 2012, general hardware 2014, building supplies 2016, landscaping 2018, etc. Further, the user interface 2000 also provides the supplier name, phone number, address, website and other contact information (2020-2034). In addition, the user interface indicates what supplies are available from each supplier (2036-2088). For example, Vern's Home Center 2024 provides supplies for plumbing 2052, electrical 2054, general hardware 2056, and landscaping 2058. The user interface 2000 shown in FIG. 20 is provided to the customer by clicking the my Resources link 415 and the Purchase Supplies link 2001. Another exemplary user interface may show customer reviews for each supplier.

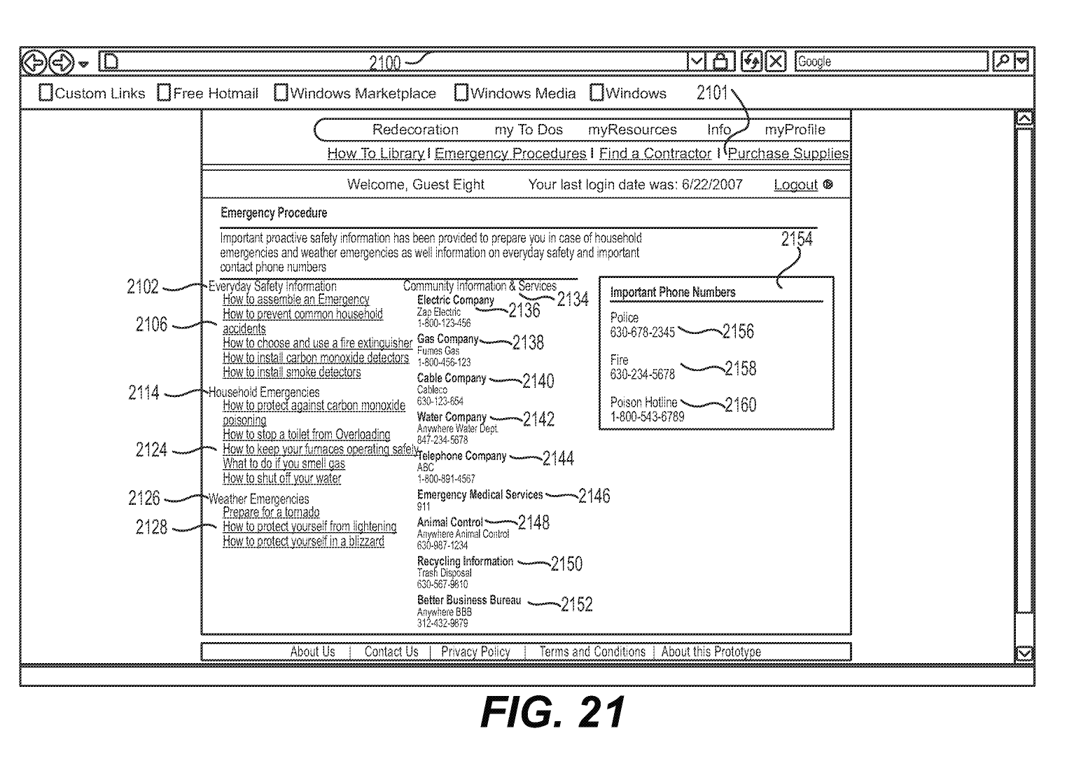

FIG. 21 is an exemplary user interface 2100 that provides information on emergency procedures. These include, but are not limited to, everyday safety 2102, household emergency 2114, and weather emergency information 2126. Exemplary procedures may include How to Prevent Common Household Accidents 2106, How to Keep Your Furnaces Operating Safely 2124, and How to Protect Yourself from Lightning 2128. The home management system may also display contact information for local utility companies (2134-2152) and government safety agencies (2154-2160). The user interface 2100 shown in FIG. 21 is provided to the customer by clicking the my Resources link 415 and the Emergency Procedures link 2101.

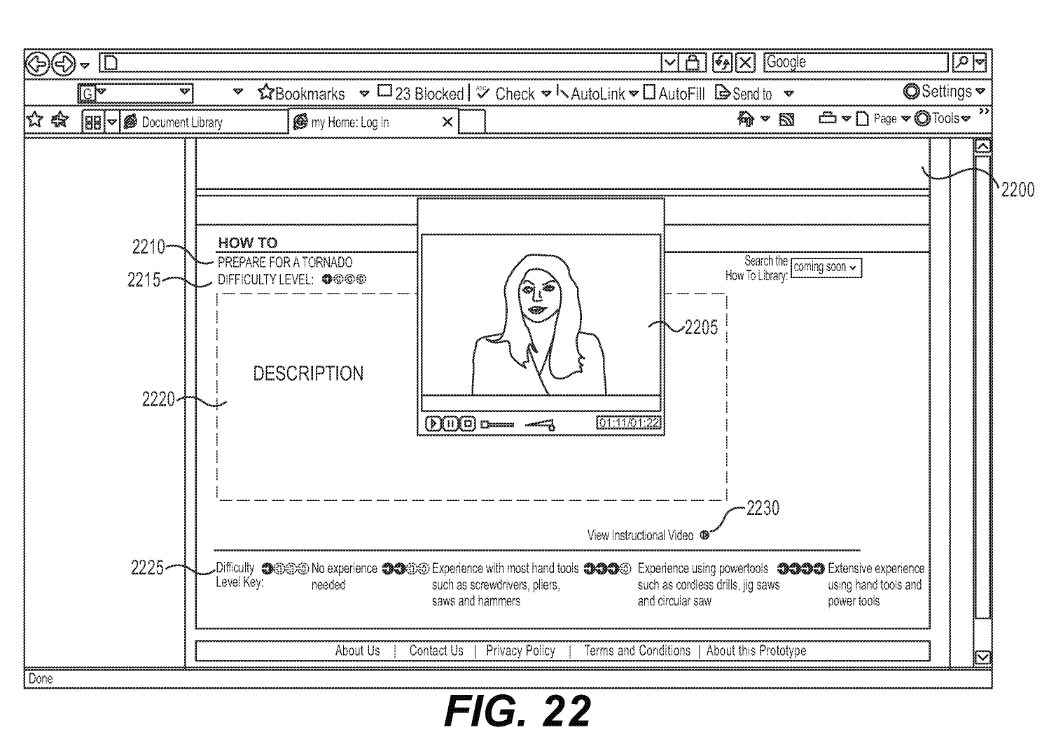

FIG. 22 is an exemplary user interface 2200 that provides information on a particular emergency procedure (e.g. Prepare for A Tornado 2210). It provides the customer with the difficulty level of the project 2215 (difficulty key is also provided 2225), the tools and experience needed as well as a description of the project 2220. The home management system may also provide an instructional video for the project 2205 by clicking a link 2230.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electronic home management system comprising:
an application server capable of transmitting and receiving data over a communication network;
a database capable of storing home management data;
a home management software application running on the application server and communicatively coupled to the database; and
a user interface responsive to user input, wherein said user interface displays, transmits and receives customized home management data between an authorized user and the software application.

2. The system according to claim 1, wherein the user interface interacts with the home management software application and database to display to an authorized user electronic data relating to a maintenance, redecorating, remodeling or repair project.

3. The system according to claim 2, wherein the user interface interacts with the home management software application and database to display an image of a portion of a home.

4. The system according to claim 3, wherein the user interface accepts input from an authorized user to modify the image of a portion of a home.

5. The system according to claim 4, wherein the software application includes a 2-dimensional rendering application, a 3-dimensional rendering application, a virtual reality conversion application and a virtual reality player.

6. The system according to claim 5, wherein the software application renders a new image of a portion of the home based on user input to modify the image.

7. The system according to claim 6, wherein the user interface displays the new image.

8. The system according to claim 1, wherein the database includes data gathered by a home inspector.

9. The system according to claim 1, wherein the database includes images of a portion of a home.

10. The system according to claim 3, wherein the portion of the home is selected from the group consisting of a portion of a kitchen, dining room, living room, family room, foyer, bedroom, bathroom, exterior, landscaping, attic, garage, basement, storage room, and nursery.

11. The system according to claim 1, wherein the user interface allows an authorized user to input home management data selected from a group consisting of:
(a) surface types for a portion of the home;
(b) manufacturer, model number, serial number, and owner's manual of appliances fixtures, and systems of the home;
(c) instructions to perform maintenance, redecorating, remodeling and repair projects that include text, digital images, and video;
(d) contractor information that includes contact and customer review information to perform maintenance, redecorating, remodeling and repair projects;
(e) supplier information that includes the type of supplies offered by each supplier and customer review information; and
(f) emergency procedure information that includes a description of an emergency procedure and instructional text, digital images and video to the customer to perform the project.

12. A method for capturing, modifying and displaying an image a section of a home, the method comprising:
(a) capturing an image of a section of a home to obtain a 3-dimensional bowl panoramic digital image with a digital camera;
(b) electronically masking the 3-dimensional bowl panoramic digital image for different surface types;
(c) electronically unfolding the masked 3-dimensional bowl panoramic digital image into a 2-dimensional masked digital image;
(d) receiving at least one parameter from a user, through a user interface, to render a different surface finish or material on at least one surface type of the section of the home;
(e) rendering a new surface finish or material on the 2-dimensional masked digital image using a 3-dimensional surface rendering application;
(f) creating a rendered 3-dimensional bowl panoramic digital image using the 3-dimensional surface rendering application;
(g) converting the 3-dimensional bowl panoramic digital image to a 360 degree virtual reality file using a virtual reality conversion application; and
(h) playing the 360 degree virtual reality file to the user using a virtual reality player through a user interface.

13. The method according to claim 12, further comprising the step of presenting the user, through the user interface, a list of surface types, surface materials, and surface finishes, to apply to a portion of the digital image.

14. The method according to claim 12, wherein the digital camera comprise a digital camera and lens combination wherein the camera captures an image with a resolution of at least 8.2 megapixels.

15. The method according to claim 12, wherein the section of the home is selected from the group consisting of a kitchen, dining room, living room, family room, foyer, bedroom, bathroom, exterior, landscaping, attic, garage, basement, storage room, and nursery.

16. The method according to claim 12, wherein the surface type is selected from the group consisting of a walls, trim, floor, cabinetry, countertops, molding, shelving, carpet, doors, siding, lawn, garden, appliances, and fixtures.

17. A home management method comprising the steps of:
inspecting a home for maintenance, redecorating, remodeling or repair projects;
capturing electronic images of at least one section of the home, wherein the images include a 2-dimensional image and a 3-dimensional bowl panoramic image of the same section of the home;
publishing a home inspection report and displaying at least a portion of a captured image to a personalized user website;
receiving user input via a user interface to modify the surface materials or finishes on surface types on the portion of the displayed image; and
displaying a new image as modified according to user input.

18. The method according to claim 17 wherein the user website includes maintenance, redecorating, remodeling, and repair project information from the home inspection report, and a catalog of appliances, fixtures, and systems of the home, and library, emergency procedure, contractor, and supplier information.

19. The method according to claim 17, further comprising:
scheduling at least one contractor to perform services for maintenance, redecoration, remodeling and repair projects over the user interface, across a communication network, or delivery of materials for the projects by at least one supplier;
authorizing payment of at least one contractor that have performed maintenance, remodeling, redecoration, and repair projects over the user interface, across the communication network, or at least one supplier that have delivered supplies for the projects;
storing home inspection reports, digital images, and third party content in at least one database; and
accessing database information to display to the customer on the user interface across the communication network.

20. The method according to claim 17, the method further comprising:
notifying a call center of a customer order for a personal customer website that includes maintenance, redecorating, remodeling, and repair project information from the home inspection report, and the catalog of appliances, fixtures, and systems of the home, and library, emergency procedure, contractor, and supplier information;
notifying a customer of a customer website that includes maintenance, redecorating, remodeling, and repair project information from the home inspection report, and the catalog of appliances, fixtures, and systems of a home, and library, emergency procedure, contractor, and supplier information.
